(19) United States
(12) Patent Application Publication
(10) Pub. No.: US 2013/0221685 A1
(43) Pub. Date: Aug. 29, 2013

(54) SELF PRESENTING SECONDARY HOOD RELEASE

(71) Applicants: Joseph M. Polewarczyk, Rochester Hills, MI (US); Kevin G. Kolpasky, Oakland Township, MI (US)

(72) Inventors: Joseph M. Polewarczyk, Rochester Hills, MI (US); Kevin G. Kolpasky, Oakland Township, MI (US)

(73) Assignee: GM GLOBAL TECHNOLOGY OPERATIONS LLC, DETROIT, MI (US)

(21) Appl. No.: 13/403,090

(22) Filed: Feb. 23, 2012

(51) Int. Cl. E05C 3/14

(52) U.S. Cl. 292/52

(57) ABSTRACT

A hood release assembly for a vehicle. The hood release assembly may include a primary hood release and a secondary hood release. The secondary hood release may include a secondary latch including a secondary catch to hold the hood in a partial release position; a secondary release lever pivotally mounted to the secondary latch and including a release handle having an extended position wherein the release handle extends forward past a front edge of the hood and a retracted position; a hood release spring biases the secondary release lever toward the extended position; and a secondary cam lever having a camming surface slidably engaged with the secondary release lever and configured to cause the secondary release lever to be in the retracted position when the hood is in the closed position and in the extended position when the hood is in the partial release position.

### BACKGROUND OF INVENTION

The present invention relates generally to a hood release assembly for a motor vehicle.

A typical hood for an automotive vehicle is held in a fully closed position by a primary hood latch, and is held in a partial release position by a secondary hood latch. The secondary hood latch assures that, if the primary hood latch is inadvertently released, the hood will not open until one also releases the secondary latch. The secondary latch is typically hidden under the hood near the front edge of the hood. One concern with the secondary latch is that the release for the secondary latch is often hard to reach when the hood is in its partial release position as there is only a small vertical gap between the front edge of the hood and the front vehicle structure, and, in addition, the area under the hood is typically dark, making the location of the latch release difficult to find. It is desirable, then, to provide a way to release the secondary latch that is both convenient and yet typically hidden so as to not take away from the aesthetics of the vehicle.

### SUMMARY OF INVENTION

An embodiment contemplates a hood release assembly for a vehicle having a hood mounted adjacent to a front end vehicle structure. The hood release assembly may include a primary hood release configured to selectively hold the hood in a closed position, and a secondary hood release. The secondary hood release assembly may include a secondary latch pivotally mounted to the front end vehicle structure and including a secondary catch configured to selectively hold the hood in a partial release position; a secondary release lever pivotally mounted to the secondary latch and including a release handle extending from an extension arm, the secondary release lever having an extended position wherein the release handle extends forward past a front edge of the hood and a retracted position wherein the release handle extends under the hood behind the front edge; a hood release spring configured to pivotally bias the secondary release lever toward the extended position; and a secondary cam lever slidable vertically relative to the secondary release lever, having a camming surface slidably engaged with the secondary release lever and a hood impact surface configured to engage the hood when the hood is in the closed position and the partial release position, the camming surface configured to cause the secondary release lever to be in the retracted position when the hood is in the closed position and in the extended position when the hood is in the partial release position.

An embodiment contemplates a method of opening a hood on a vehicle using a hood release assembly, the method comprising the steps of: pivotally biasing a secondary release lever toward an extended position, the extended position having a secondary release handle that extends forward past a front edge of the hood; when the hood is in a closed position, holding the secondary release lever in a retracted position, wherein the release handle extends under the hood behind the front edge, the hood pressing down on a secondary lever cam to hold the secondary release lever in the retracted position against the pivotal bias; releasing a primary latch assembly, moving the hood from a closed position to a partial release position wherein a secondary catch holds the hood in the partial release position; moving the secondary lever cam upward as the hood moves from the closed position to the partial release position, the upward movement sliding a camming surface against the secondary release lever, allowing the pivoting bias to pivot the secondary release lever to the extended position; and pushing on the secondary release lever extending forward of the front edge of the hood to thereby release the secondary catch.

An advantage of an embodiment is that the secondary hood release is easy to access and actuate when the hood is in its partial release position while being hidden from view when the hood is in its closed position. This is accomplished while having a relatively simple and easy to install, inexpensive and reliable secondary hood release assembly. In addition, the secondary release lever automatically retracts when the hood is closed and even allows for hood overtravel during hood closing, without risk of damaging the assembly.

### BRIEF DESCRIPTION OF DRAWINGS

FIG. 1 is a schematic view of a portion of an automotive vehicle.

FIG. 2 is a schematic, perspective view of a portion of a secondary hood release assembly, in a hood partial release position.

FIG. 3 is a schematic, perspective view of a portion of the secondary hood release assembly, without the hood release spring shown, in the hood partial release position.

FIG. 4 is a schematic, perspective view of a secondary lever cam and a portion of a secondary release lever, in the hood partial release position.

FIG. 5 is a schematic, perspective view of the secondary lever cam and the secondary release lever, in a hood closed position.

### DETAILED DESCRIPTION

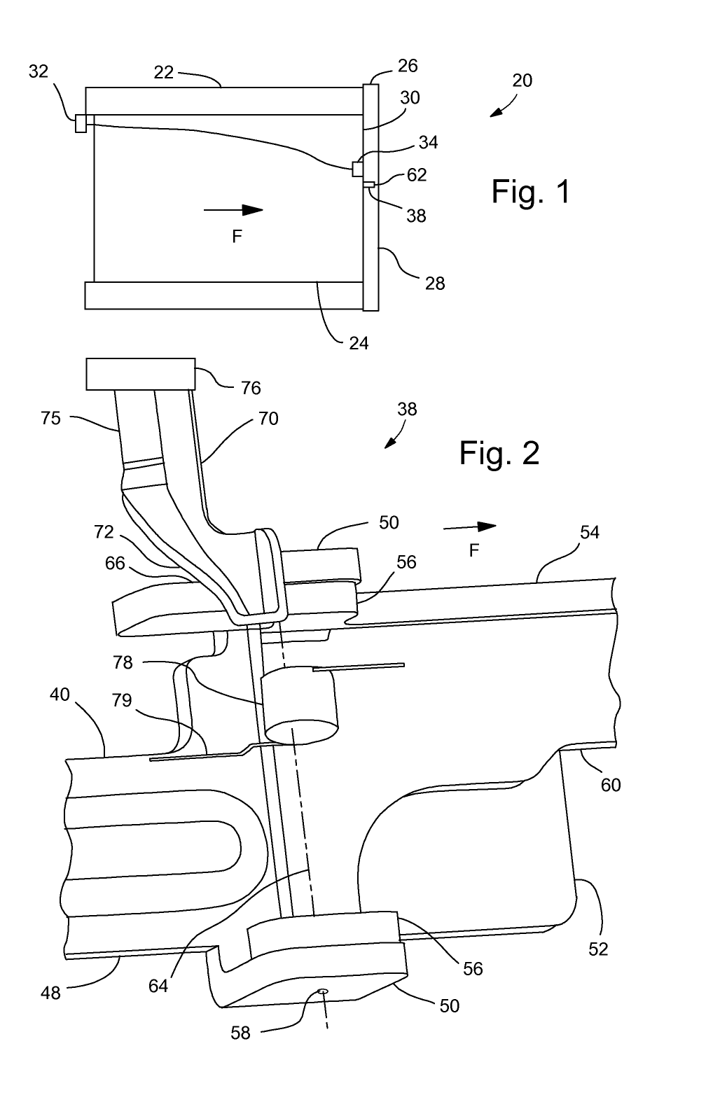

Referring to FIG. 1, a portion of vehicle, indicated generally at 20, is shown. The vehicle 20 includes side vehicle structure 22, such as a pair of fenders, with a hood 24 pivotally mounted between the fenders. Front end vehicle structure 26, such as a front bumper, grille or other structure, defines the vehicle front end 28, which is adjacent to a front edge 30 of the hood 24. An arrow marked F (as shown in each figure) indicates the forward (front) direction of the vehicle 20.

The vehicle 20 may also include a primary hood release 32, which may include a hood release lever or button that is connected to a primary latch assembly 34. The primary hood release 32 and primary latch assembly 34 may be conventional and so will not be shown in detail herein.

The primary latch assembly 34 holds the hood 24 in its closed position, where the hood 24 is essentially flush with the top surfaces of the fenders. Upon actuating the primary hood release 32, the primary latch assembly 34 releases the hood 24, allowing the hood 24 to pivot upward to a partial release position. In this partial release position, the hood 24 allows for a small gap between the front edge 30 of the hood 24 and the front end vehicle structure 22, but a secondary hood release assembly 38 prevents the hood 24 from opening any farther until the secondary hood release assembly 38 also releases the hood 24. After this second release, one may pivot the hood 24 upward to its full open position.

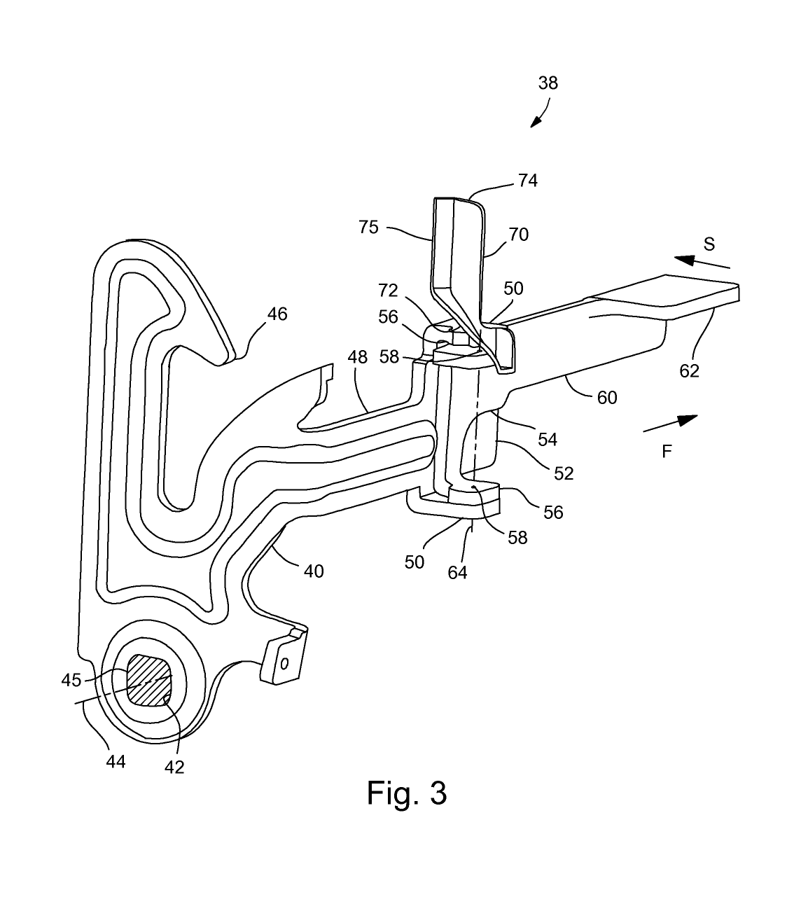

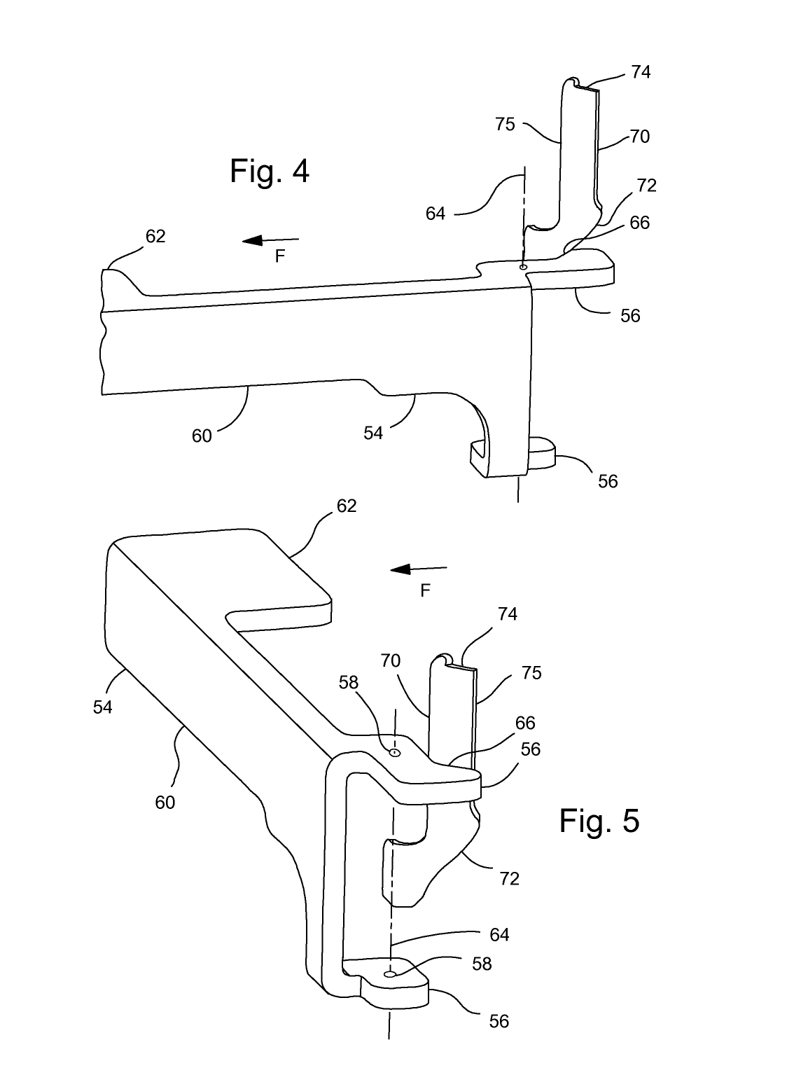

The secondary hood release assembly 38 will be discussed relative to FIGS. 1-5. This assembly 38 includes a secondary latch 40 having a mounting hole 42 centered about a secondary latch pivot axis 44. A conventional bolt, shaft, boss or other conventional member supported by vehicle structure may be mounted in the hole 42 to support and allow for pivoting of the secondary latch 40 about the secondary latch pivot axis 44. A spring or other conventional biasing member may be employed to pivotally bias the secondary latch 40 in a clockwise direction as viewed in FIG. 3. The secondary latch 40 also includes a secondary catch (hook) 46, which is configured to selectively engage a conventional hood mounted striker and hold the hood 24 in the hood partial release position (after the primary latch assembly 34 is released). The secondary latch 40 also includes a support arm 48 that extends away from the mounting hole 42 and supports a pair of secondary latch engagement flanges 50, which are pivotally engaged with a secondary release lever 54, and a pivot stop flange 52.

The secondary release lever 54 includes a pair of release lever engagement flanges 56 that mate with and are pivotally connected to the secondary latch engagement flanges 50 via pivot pins 58. The pivot pins 58 cause the secondary release lever 54 to pivot about a release lever pivot axis 64. The secondary release lever 54 also includes an extension arm 60 extending away from the release lever engagement flanges 56 to a secondary release handle 62. The extension arm 60 and secondary release handle 62 are long enough so that the secondary release handle 62 will extend out past the front edge 30 of the hood 24 when the hood is in the hood partial release position. A cam engagement surface 66 is defined by the upper of the two release lever engagement flanges 56.

The secondary hood release assembly 38 also includes a secondary lever cam 70, which includes a camming surface 72 that engages and slides generally vertically along the cam engagement surface 66. The camming surface 72 is shaped so that, when the secondary lever cam 70 is raised, the cam allows the secondary release lever 54 to pivot forward, and when the secondary lever cam 70 is lowered, the cam pushes the secondary release lever 54 so that it is oriented extending toward a side of the vehicle 20. A generally vertically extending over-slam flat portion 75 extends upward from the camming surface 72. Cam support vehicle structure 76 is fixed relative to the vehicle and supports the secondary lever cam 70 so that it is only allowed to slide up and down vertically. A hood impact surface 74 on top of the secondary lever cam 70 is configured to engage with the an underside surface of the hood 24, such as a hood bumper.

The secondary hood release assembly 38 also includes a hood release spring 78 that is mounted between and pivotally biases the secondary release lever 54 toward an extended position where the secondary release handle 62 extends sideways rather than forward from under the front edge 30 of the hood 24.

The operation of a hood release will now be discussed with respect to FIGS. 1-5. When the hood 24 is held in the hood closed position by the primary latch assembly 34, the underside surface of the hood 24 is pressed against the hood impact surface 74, holding the secondary lever cam 70 in a downwardly extended position where the over-slam flat portion 75 is engaged with the cam engagement surface 66 of the secondary release lever 54. This holds the extension arm 60 of the secondary release lever 54 in a sideways extending position (see FIG. 5) against the bias of the hood release spring 78, with the secondary release handle 62 hidden under the hood 24.

When the primary hood release 32 is actuated, the primary latch assembly 34 releases the hood 24, which pivots upwards a small amount until the secondary catch 46 engages with a striker on the underside of the hood 24. This is the hood partial release position. As the hood 24 moves from the closed position to the hood partial release position, the hood release spring 78 biases the secondary release lever 54 toward an extended position. During this movement of the hood 24, the hood release spring 78 causes the cam engagement surface 66 to press against the camming surface 72, which causes the secondary lever cam 70 to lift upward with the rising hood 24. The upward movement of the secondary lever cam 70 now allows the secondary release lever 54 to pivot the extension arm 60, about the release lever pivot axis 64, to a forward extending position where the secondary release handle 62 extends out from under the front edge 30 of the hood 24 in the small gap between the hood 24 and the front end vehicle structure 26. The secondary release lever 54 stops pivoting outward when the extension arm 60 comes into contact with the pivot stop flange 52, which stops the pivoting at the desired location. One then can easily see and reach the secondary release handle 62.

To fully open the hood 24, one pushes the secondary release handle 62 in the direction of arrow S in FIG. 3. This causes the secondary release lever 54 to press against the secondary latch 40, which in turn causes the secondary latch 40 to pivot about the secondary latch pivot axis 44. As it pivots, the secondary catch 46 rotates out of engagement with a conventional striker on the underside of the hood 24, releasing the hood 24. The hood 24 can now be lifted into its fully open position.

To close the hood 24, one pushes down on the hood 24 until it pivots down into its closed position. As the hood 24 pivots downward, it eventually reaches the hood partial release position, at which time, the underside of the hood 24 begins pressing down on the secondary lever cam 70. As the hood 24 continues traveling downward, the camming surface 72 slides downward, causing the secondary release lever 54 to pivot back under the front edge of the hood 24 against the bias of the hood release spring 78 just prior to the hood 24 moving into its closed position, where the conventional primary latch assembly 34 holds the hood 24 in the closed position. Thus, the secondary release handle 62 is automatically extended and retracted during hood opening and closing operations, making secondary hood release easy and quick for a person wishing to open the hood 24.

In addition, during this closing motion, should the hood 24 overtravel (i.e., move slightly past the closed position), the over-slam flat portion 75 allows the secondary lever cam 70 to move downward this extra distance without the risk of any components sustaining damage.

While certain embodiments of the present invention have been described in detail, those familiar with the art to which this invention relates will recognize various alternative designs and embodiments for practicing the invention as defined by the following claims.

What is claimed is:

1. A hood release assembly for a vehicle having a hood mounted adjacent to a front end vehicle structure comprising:
a primary hood release configured to selectively hold the hood in a closed position; and
a secondary hood release assembly including:
a secondary latch pivotally mounted to the front end vehicle structure and including a secondary catch configured to selectively hold the hood in a partial release position;
a secondary release lever pivotally mounted to the secondary latch and including a release handle extending from an extension arm, the secondary release lever having an extended position wherein the release handle extends forward past a front edge of the hood and a retracted position wherein the release handle extends under the hood behind the front edge;
a hood release spring configured to pivotally bias the secondary release lever toward the extended position; and
a secondary cam lever slidable vertically relative to the secondary release lever, having a camming surface slidably engaged with the secondary release lever and a hood impact surface configured to engage the hood when the hood is in the closed position and the partial release position, the camming surface configured to cause the secondary release lever to be in the retracted position when the hood is in the closed position and in the extended position when the hood is in the partial release position.

2. The assembly of claim 1 wherein the secondary latch includes a pair of secondary latch engagement flanges and the secondary release lever includes a pair of release lever engagement flanges that pivotally engage the secondary latch engagement flanges for pivoting about a release lever pivot axis.

3. The assembly of claim 2 wherein the hood release spring is centered about the release lever pivot axis and is configured to press against the secondary latch and the secondary release lever to bias the secondary release lever toward the extended position.

4. The assembly of claim 2 wherein one of the pair of release lever engagement flanges includes a cam engagement surface in sliding surface contact with the camming surface of the secondary cam lever.

5. The assembly of claim 1 wherein the secondary release lever includes a release lever engagement flange having a cam engagement surface in sliding surface contact with the camming surface of the secondary cam lever.

6. The assembly of claim 5 wherein the secondary cam lever includes an overslam flat portion adjacent to the camming surface, the overslam flat portion configured to be in sliding engagement with the cam engagement surface when the hood travels beyond the closed position during a hood closing event.

7. The assembly of claim 1 wherein the secondary cam lever includes an overslam flat portion adjacent to the camming surface configured to engage the secondary release lever when the hood travels beyond the closed position during a hood closing event.

8. A method of opening a hood on a vehicle using a hood release assembly, the method comprising the steps of:
(a) pivotally biasing a secondary release lever toward an extended position, the extended position having a secondary release handle that extends forward past a front edge of the hood;
(b) when the hood is in a closed position, holding the secondary release lever in a retracted position, wherein the release handle extends under the hood behind the front edge, the hood pressing down on a secondary lever cam to hold the secondary release lever in the retracted position against the pivotal bias;
(c) releasing a primary latch assembly, moving the hood from a closed position to a partial release position wherein a secondary catch holds the hood in the partial release position;
(d) moving the secondary lever cam upward as the hood moves from the closed position to the partial release position, the upward movement sliding a camming surface against the secondary release lever, allowing the pivoting bias to pivot the secondary release lever to the extended position; and
(e) pushing on the secondary release lever extending forward of the front edge of the hood to thereby release the secondary catch.
